(19) United States
(12) Patent Application Publication
(10) Pub. No.: US 2011/0203724 A1
(43) Pub. Date: Aug. 25, 2011

(54) Composite Wood Products and Methods for Manufacturing the Same

(75) Inventors: William R. Stokes, JR., Greer, SC (US); William H. Crostic, JR., Simpsonville, SC (US)

(73) Assignee: Guardian Building Products, Greer, SC (US)

(21) Appl. No.: 13/088,802

(22) Filed: Apr. 18, 2011

Related U.S. Application Data
(63) Continuation-in-part of application No. 12/120,447, filed on May 14, 2008.

(51) Int. Cl. B32B 38/06

(52) U.S. Cl. 156/221; 156/309.9

(57) ABSTRACT

In accordance with one embodiment of the present disclosure a method for making a composite wood product is provided. The method includes extruding a mass having fiber material and thermoplastic resin to form a composite wood base. The method further includes heating the composite wood base and laminating a sheet of surface material onto the composite wood base with a film application device to form a composite wood product, the film application device capable of wrapping a single sheet of the surface material onto the top, bottom, and side surfaces of the composite wood base.

### BACKGROUND

Wood composites are increasingly being utilized as a replacement material for traditional solid wood products. Wood composites generally contain wood and thermoplastic polymers. Such composites are formed for use in many of the same applications as a solid wood product while offering advantages such as high resistance to insect penetration and moisture damage.

Conventional wood composites include various additives to add color and protect against mildew, ultraviolet light exposure, discoloration or the like. However, additives can be very expensive, particularly when they are incorporated throughout the entire wood composite. In an effort to decrease the usage of such materials, multi-layer wood composite products have been utilized. Multi-layer wood composite products can include a substrate layer with a cap layer disposed on at least one surface of the substrate layer. By limiting the additives to the cap layer, costs can be reduced while still providing the desired protection. However, conventional methods of forming multi-layer wood composite products are still lacking with respect to efficiency and cost savings.

For example, multi-layer products are often formed utilizing co-extrusion methods in which extrudates are extruded through separate orifices of a single die and merged to form multiple layers. Unfortunately, such co-extrusion methods are very costly and can still result in excess material being utilized for the cap layer(s).

Thus, a need exists for methods of forming composite products that are efficient and cost-effective. Composite wood products formed by utilizing such methods would be particularly beneficial.

### SUMMARY

Objects and advantages of the invention will be set forth in part in the following description, or may be obvious from the description, or may be learned through practice of the invention.

In accordance with one embodiment of the present disclosure a composite wood product is provided. The composite wood product has a composite wood base, the base including about 35 weight percent to about 55 weight percent fiber material and about 35 weight percent to about 55 weight percent thermoplastic resin. A surface layer is laminated on at least a portion of the base, the surface layer having a thickness of about 0.01 millimeters to about 0.5 millimeters, the surface layer including about 0.5 weight percent to about 10 weight percent pigment and about 45 weight percent to about 75 weight percent polyolefin or copolymer thereof.

In another embodiment of the present disclosure a method for making a composite wood product is provided. The method includes extruding a mass having fiber material and thermoplastic resin to form a composite wood base, the base including about 35 weight percent to about 55 weight percent fiber material and about 35 weight percent to about 55 weight percent thermoplastic resin. A surface material is laminated on at least a portion of the base to form a surface layer, the surface layer having a thickness of about 0.01 millimeters to about 0.5 millimeters, the surface layer including about 0.5 weight percent to about 10 weight percent pigment and about 45 weight percent to about 75 weight percent polyolefin or copolymer thereof.

In still other embodiments of the present disclosure a method for making a composite wood product is provided. The method includes extruding a mass having fiber material and thermoplastic resin to form a composite wood base. The method further includes heating the composite wood base and laminating a sheet of surface material onto the composite wood base with a film application device to form a composite wood product, the film application device capable of wrapping a single sheet of the surface material onto the top, bottom, and side surfaces of the composite wood base.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figure in which:

FIG. 1 illustrates a perspective view of a composite wood board in accordance with certain embodiments of the present disclosure;

FIG. 2 illustrates a schematic view of a system that can be used in accordance with certain embodiments of the present disclosure;

FIG. 3 illustrates a schematic view of a system that can be used in accordance with certain embodiments of the present disclosure;

FIG. 4A illustrates a perspective view of a film application section in the process illustrated in FIG. 3 in accordance with certain embodiments of the present disclosure;

FIG. 4B illustrates an expanded view of the film application section illustrated in FIG. 4A in accordance with certain embodiments of the present disclosure;

FIG. 5 illustrates a perspective view of a film application section in the process illustrated in FIG. 3 in accordance with certain embodiments of the present disclosure; and

FIGS. 6A-C, 7A-C, and 8A-D, illustrate wrapping steps of a film application section in the process illustrated in FIG. 3 in accordance with certain embodiments of the present disclosure.

Repeat use of reference characters in the present specification and drawings is intended to represent same or analogous features or elements of the disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure is generally directed to methods for making a composite wood product. The methods include providing a mass having fiber material and thermoplastic resin, extruding the mass to form a composite wood base, and laminating a surface material on at least a portion of the base to form a surface layer, the surface layer having a thickness of from about 0.01 millimeters to about 0.5 millimeters.

Additionally, the present disclosure describes a composite wood product having a composite wood base formed from fiber material and thermoplastic resin. A surface layer is laminated on at least a portion of the base with the surface layer having a thickness of from about 0.01 millimeters to about 0.5 millimeters.

The methods described herein do not require the use of expensive and inefficient co-extrusion processes. Rather, the present methods allow for a very thin surface layer to be laminated onto the surface of a composite wood base thereby decreasing the costs required for expensive additives. Such a process can significantly decrease the amount of additives required to form a composite wood product. For instance, the methods of the present disclosure can be utilized to form a wood base without any pigments being utilized. Rather, the pigments can be added to the surface layer which is laminated onto the surface of the composite wood base providing an aesthetically pleasing appearance to the composite wood product while reducing the amount of pigment necessary. In this manner, the present methods are more cost-effective and efficient than conventional methods.

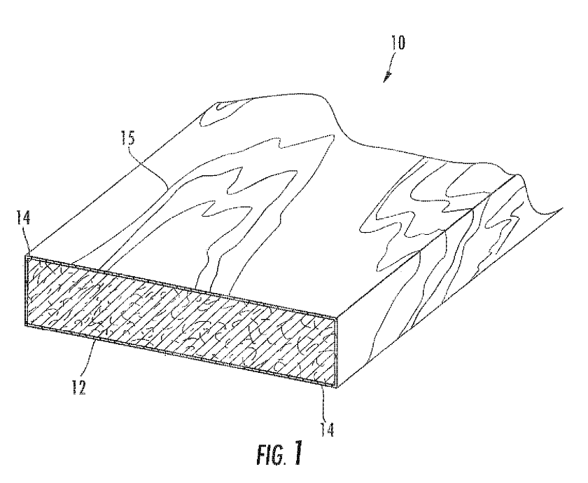

Referring to FIG. 1, a composite wood product in accordance with one embodiment of the present disclosure is illustrated. The composite wood product is particularly contemplated for use in decking applications, as illustrated by the composite wood product 10 of FIG. 1. However, the products described herein are equally suitable for other applications, including, but not limited to, siding, floor tiles, paneling, moldings, steps, door and window sills and sashes, outdoor furniture, fencing, playground equipment, posts and barn components, and marine items such as decking, bulkheads and pilings, and the like. In this regard, the composite wood product can have suitable dimensions as would be known in the art. For example, for decking applications, the composite wood product can be formed to standard sizes, such as from about 2 inches thickness by 4 inches width and any suitable length.

The composite wood product 10 includes a base 12 that generally contains about 35 weight percent to about 55 weight percent fiber material, more particularly from about 40 weight percent to about 50 weight percent fiber material, and still more particularly from about 45 weight percent to about 50 weight percent fiber material. In this regard, fiber material can include wood fiber, glass fiber, cotton fiber, carbon fiber, graphite fiber, and combinations thereof. Preferably, the fibers can be cellulosic and derived from recycled paper products, such as agrifibers, pulp, newsprint, soft woods, such as pine, or hard woods from deciduous trees. Hard woods are generally preferred for fiber manufacture because they absorb less moisture, can cost less than other wood types, and can contribute more structural value to the composite wood product. In embodiments in which hard wood is utilized as the primary source of fiber, additional fiber make-up can be derived from secondary sources including soft wood fibers, natural fibers including bamboo, rice, sugar cane, and recycled or reclaimed fiber from newspapers, cardboard boxes, or the like, and combinations thereof.

The base 12 also generally contains about 35 weight percent to about 55 weight percent thermoplastic resin, more particularly from about 40 weight percent to about 50 weight percent thermoplastic resin, and still more particularly from about 45 weight percent to about 50 weight percent thermoplastic resin. Preferably, the thermoplastic resin can include a polyolefin or copolymer thereof, such as polypropylene, and may be entirely polypropylene. However, other suitable thermoplastic resins can be utilized in combination with or separately from polypropylene. For example, polyvinyl chloride, polyethylene, nylon, polyesters, polysulfones, polyphenylene oxide and sulphide, epoxies, cellulosics, and combinations thereof are also suitable thermoplastic resins that can be used in connection with the present disclosure.

In certain embodiments, the base 12 can also include one or more additional additives. For example, coupling agents, impact modifiers, thermal stabilizers, reinforcing agents, lubricants, plasticizers, organic and inorganic pigments, UV stabilizers, filler material, biocides, processing aids, flame retardants, and combinations thereof can all be utilized in connection with the present disclosure. Such additives can be individually present in an amount from about 0.5 weight percent to about 5 weight percent.

The thickness of the base 12 can vary depending on the particular application of the composite wood product. In certain embodiments, the base 12 can have a thickness of about 10 millimeters to about 60 millimeters, particularly from about 20 millimeters to about 55 millimeters thickness, more particularly, about 25 millimeters thickness. The thicknesses can vary as would be understood by one skilled in the art depending upon application for the composite wood product.

In addition, the composite wood product 10 includes a surface layer 14. The surface layer 14 generally contains about 45 weight percent to about 75 weight percent thermoplastic resin, more particularly from about 60 weight percent to about 70 weight percent thermoplastic resin, and still more particularly from about 65 weight percent to about 70 weight percent thermoplastic resin. Again, preferably the thermoplastic resin includes a polyolefin or copolymer thereof, such as polypropylene (and may be entirely polypropylene) but any suitable thermoplastic resin as described herein is contemplated by the present disclosure. For instance, other suitable thermoplastic resins that can be utilized in combination with or separately from polypropylene include polyvinyl chloride, polyethylene, nylon, polyesters, polysulfones, polyphenylene oxide and sulphide, epoxies, cellulosics, and combinations thereof.

The surface layer 14 further includes one or more pigments. The pigment is present in the surface layer 14 in an amount of about 0.5 weight percent to about 15 weight percent, particularly from about 1 weight percent to about 10 weight percent, more particularly from about 1 weight percent to about 3 weight percent. In this regard, suitable pigments can include organic and inorganic pigments as would be known in the art. It has been determined that the surface layer 14 can beneficially provide color to the composite wood product 10 utilizing a fraction of the pigment that would be required in conventional products. The surface layer 14 can serve to cover the composite wood base 12, thereby minimizing the amount of pigment required in the composite wood base 12. For instance, suitable pigments can include color-fast and/or UV stable pigments such as iron oxide based pigments. In certain embodiments, an IR-reflective pigment can be utilized to reduce the heat build-up from sunlight in decking applications.

In certain embodiments, the surface layer 14 can also include one or more additional additives. For example, UV stabilizers, filler material, biocides, processing aids, flame retardants, and combinations thereof can all be utilized in connection with the surface layer 14. Such additives can be individually present in an amount from about 1 weight percent to about 60 weight percent, depending on the additive.

The surface layer 14 can have a thickness of about 0.01 millimeters to about 0.5 millimeters, particularly from about 0.01 millimeters to about 0.1 millimeters. Additionally, the surface layer 14 can have surface designs 15 present. For instance, in certain embodiments, the surface design 15 can simulate wood grain. However, other patterns can also be utilized for surface design 15 if desired. Furthermore, the surface layer 12 can be present on one or more surfaces of the composite wood base 12. A surface can refer to any surface of wood base 12 including the top surface, bottom surface, or one or both side surfaces. In certain embodiments, the surface layer 12 can completely wrap the composite wood base 12.

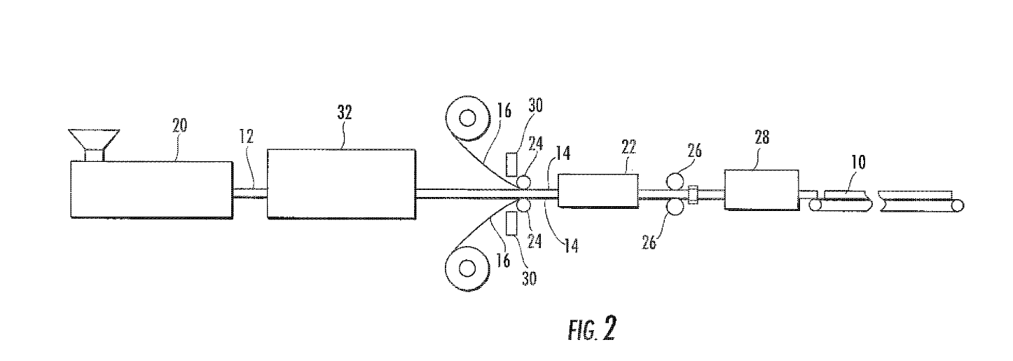

Turning to FIG. 2, methods for manufacturing composite wood products in accordance with the present disclosure will be discussed in more detail. The methods can be carried out in a single manufacturing line so as to form the completed composite wood product 10.

The composite wood base 12 of the present disclosure is formed by extrusion processes. Such extrusion processes are generally well known in the art. It is generally preferred that the materials forming a mass of materials are present in pelletized form. As discussed above, in addition to the fiber material and thermoplastic material, various additives can also be added to the mass of materials prior to extrusion. All of the various materials added to the mass of materials should be present in a size and shape sufficient to form a composite wood product 10 having the characteristics described herein.

A blowing agent or gas can also be added to the mass to reduce the density and weight of the composite wood product 10 by foaming. If a blowing agent is utilized, it is mixed into the mass during blending or at the extruder inlet. In the extruder, the blowing agent is decomposed, disbursing gas, such as nitrogen or CO₂, into the melt. As the extrudate exits the extrusion die, the gas sites experience a pressure drop expanding into small cells or bubbles trapped by the surrounding polymer. This allows the composite wood product 10 described herein to be significantly lighter than conventional composite wood products.

For example, in certain embodiments, the wood base 12 can be formed by introducing materials including respective quantities of a fiber material and thermoplastic material into the inlet of an extruder 20. Preferably, the weigh blender is positioned immediately above the extruder 20, at the extruder inlet, so that the mass of materials is formed immediately prior to entering the extruder 20, thus minimizing or preventing separation of the materials. The materials are then extruded at temperatures and pressures as would be known in the art through the extruder barrel and out the extrusion die to form the composite wood base 12. The composite wood base 12 can be extruded into any suitable shape and/or size depending upon the intended application. After extrusion, the composite wood base 12 can be permitted to cool or can be cooled by any suitable method as would be known in the art, such as a cooling station 32.

After the composite wood base 12 is formed, it is heated at a temperature ranging from about 250° F. to about 375° F., more particularly from about 300° F. to about 400° F., still more particularly from about 315° F. to about 360° F. The composite wood base 12 can be heated in an oven 22 or can be heated by a suitable method as would be known in the art.

A surface material 16 is applied to one or more surfaces of the composite wood base 12, which can include top, bottom, or side surfaces of the composite wood base 12. For instance, as shown in FIG. 2, prior to heating the composite wood base 12, a surface material is applied to the composite wood base to form surface layer 14. The surface material 16 can be applied with several types of coating processes. Suitable coating methods include roll coating wherein the surface material 16 is leveled on the composite wood base by an applicator roll. Preferably, the surface material 16 is present in a rolled sheet and is applied to the composite wood base 12 by one or more rollers 24. The surface material 16 can melt onto the surface of wood base 12 to form the surface layer 14. The surface material can melt onto the surface from the heat provided by oven 22 or can be heated prior to application, such as with a heater 30. A heater 30 can apply heat to surface material 16 just prior to application on the surface of wood base 12. Again, the surface can refer to any surface of wood base 12 including the top surface, bottom surface, or one or both side surfaces. The surface material 16 adheres to the composite wood base to form a surface layer 14 on the composite wood base 12. However, the surface material 16 can be applied by any suitable method as would be known to one of ordinary skill in the art including spraying, brushing, and the like.

Once the surface layer 14 has been formed on the composite wood base 12, the surface layer 14 and/or the composite wood base 12 can be embossed with a suitable embossing device 26 to form a desired surface design in the composite wood product 10. For instance, in certain embodiments, the surface design can simulate wood grain. However, other patterns can also be utilized if desired. In certain embodiments, the embossing device 26 can assist in applying the surface material 16 to the wood base 12. It has been determined that heating the composite wood base 12 provides embossing depth improvement while drawing the thermoplastic material (which appears to have an affinity for the metal surface of an embossing roller) towards the surface which beneficially helps to seal the composite wood base 12. In certain embodiments, the embossing device 26 can be heated to achieve the temperatures desired. The embossing device 26 can emboss one or more of the top, bottom, or side surfaces of the composite wood base 12 and/or surface layer 14, either in combination or alone.

Once the composite wood product 10 has been formed, it can be cut to a desired length by a conventional cutter 28 and packaged for shipment.

It should be understood that variations can be made in the above-described process that are within the scope and spirit of the present disclosure. For instance, the above described cutting operation can be performed immediately after the composite wood base 12 is formed. Similarly, the heating of the composite wood base 12 can occur before the surface layer has been formed on the surface of the composite wood base 12.

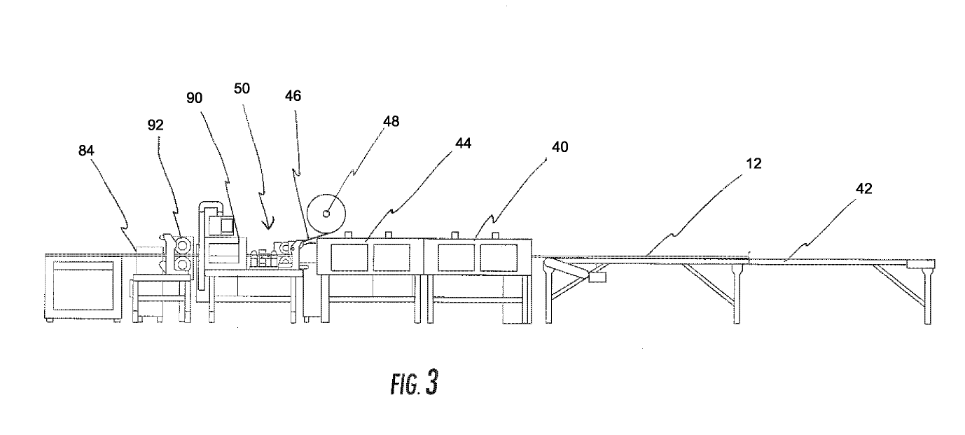

Turning to FIG. 3, still another process in accordance with the present disclosure is illustrated. A composite wood base 12 that is formed as previously described herein is fed into a first heater section 40 with an infeed conveyor 42. First heater section 40 can be heated to a temperature ranging from about 650° F. to about 850° F., more particularly from about 700° F. to about 825° F., still more particularly from about 750° F. to about 800° F. Composite wood base 12 is then fed through second heater section 44. Second heater section 44 can be heated to a temperature ranging from about 700° F. to about 950° F., more particularly from about 725° F. to about 925° F., still more particularly from about 750° F. to about 900° F. In this manner, the composite wood base 12 is heated to a temperature ranging from about 250° F. to about 450° F., more particularly from about 300° F. to about 400° F., still more particularly from about 350° F. to about 375° F.

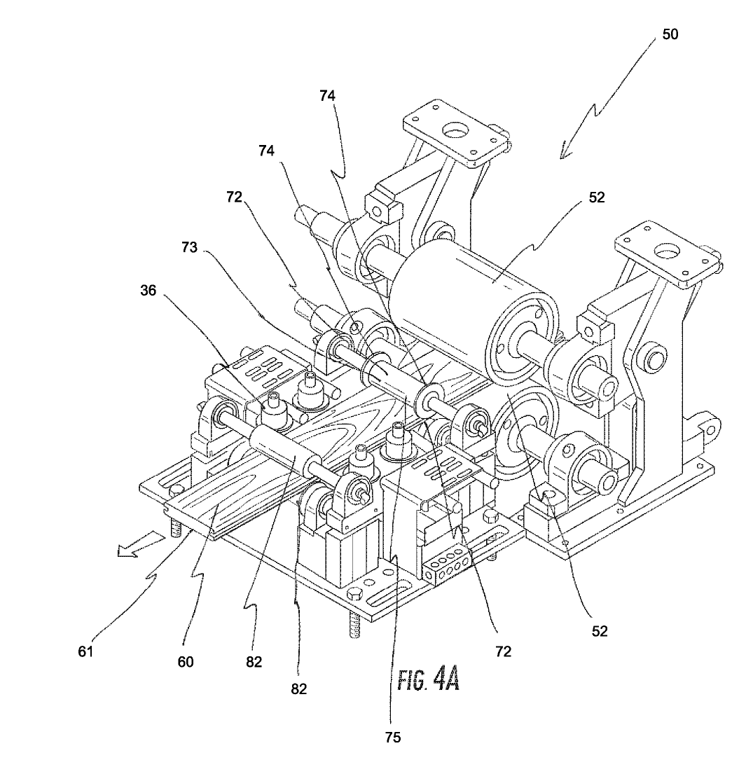

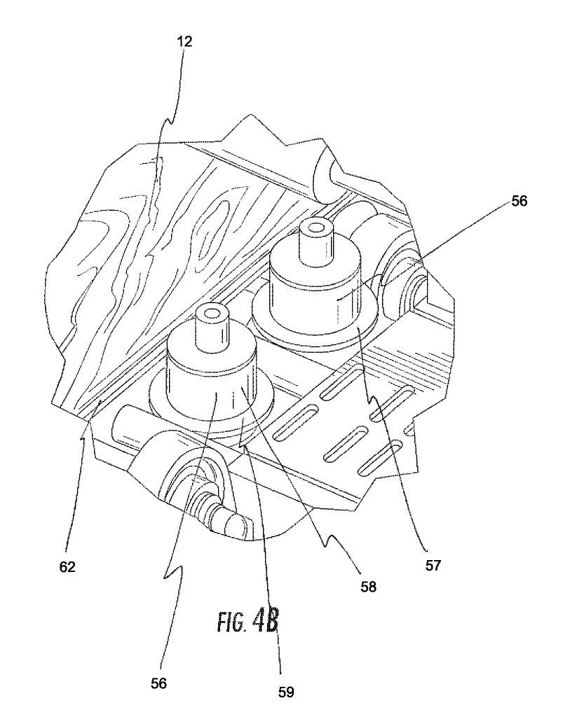

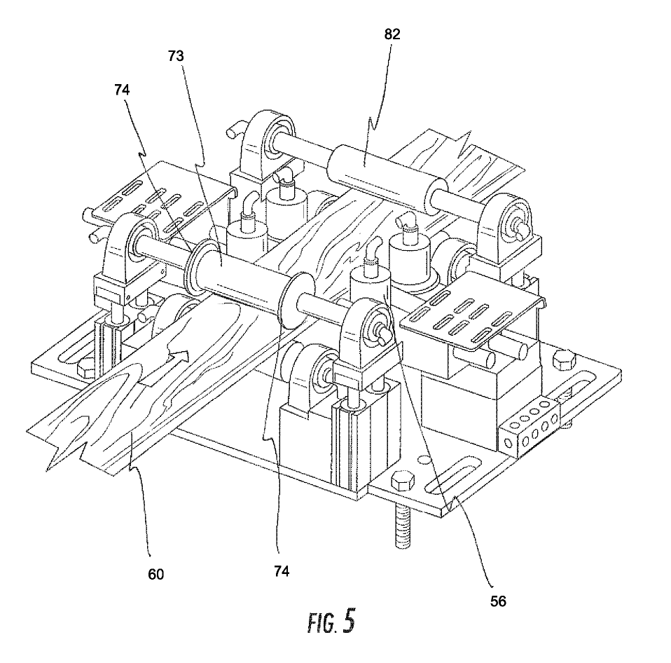

A surface material 46 is fed from film roller 48 towards composite wood base 12 and is applied to one or more surfaces of the composite wood base 12 with film application section 50. Referring to FIGS. 4A and 4B, film application section 50 includes first nip rollers 52 from which surface material 46 (not shown in FIGS. 4A, 4B, and 5) is applied to the top surface 60 of composite wood base 12. Nip rollers 52 are positioned such that they can be adjacent to top surface 60 and bottom surface 61 of composite wood base 12 and can be heated to a temperature ranging from about 200° F. to about 300° F., more particularly from about 225° F. to about 350° F., such that the surface material is heated to a temperature ranging from about 150° F. to about 225° F., more particularly from about 175° F. to about 200° F.

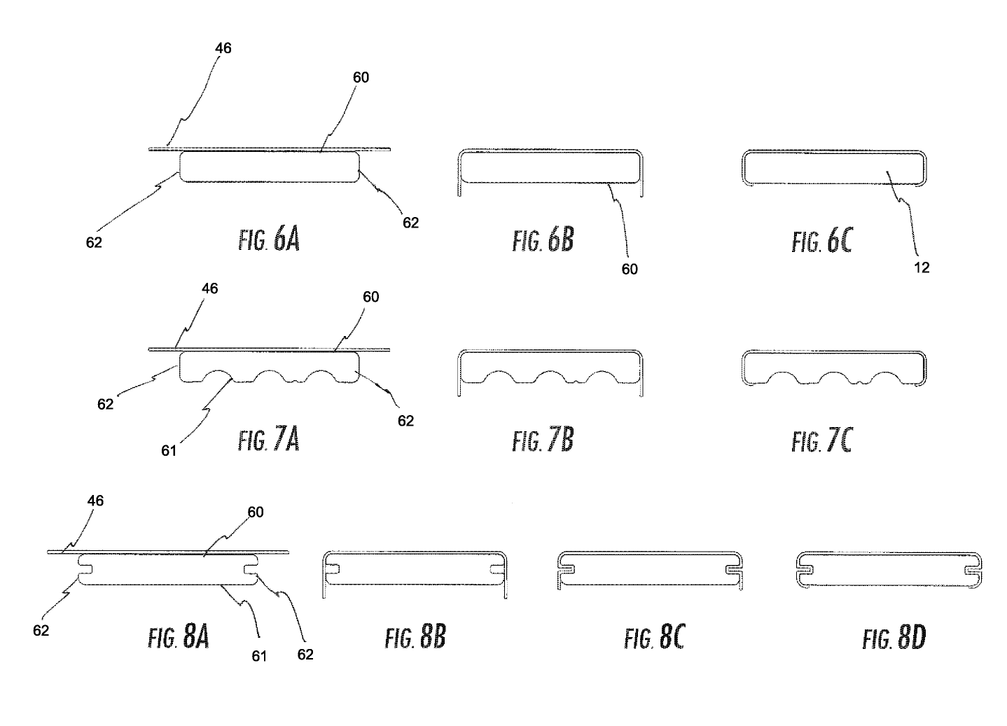

Film application section 50 includes second nip rollers 72 from which additional pressure is applied to surface material 46 to adhere surface material 46 to the top surface 60 and/or bottom surface 61 of composite wood base 12 (as shown in FIGS. 6A, 7A, and 8A). Second nip rollers 72 are positioned such that they can be adjacent to top surface 60 and bottom surface 61 of composite wood base 12. Nip rollers 72 can be temperature controlled so as to not exceed a certain temperature. As can be seen in FIG. 4A, top roller 73 includes side portions 74 which have an increased circumference when compared to the main body portion 75 of top roller. In this manner, main body portion 75 directs surface material to contact the top surface 60 of composite wood base 12 while side portions 74 fold the side edges of surface material 46 over side edges 62 of composite wood base 12 (as shown in FIGS. 6B, 7B, and 8B).

Referring to FIG. 4B, film application section 50 further includes side nip rollers 56 which apply surface material 46 to the side edges 62 of composite wood base 12. One or more side rollers 56 are positioned adjacent to each side of conveyor 42, respectively, such that each side roller can be adjacent to side edges 62 of composite wood base 12. One or more heaters can be present adjacent to such side rollers 56 and can be heated to a temperature ranging from about 500° F. to about 1000° F., more particularly from about 700° F. to about 850° F., such that the surface material is heated to a temperature ranging from about 250° F. to about 350° F., more particularly from about 275° F. to about 325° F.

Each side roller 56 can include a portion 57 which has an increased circumference when compared to the main body portion 58 of side roller. In this manner, main body portion 58 directs surface material to contact the side edge 62 of composite wood base 12 while portion 57 can fold the excess of surface material 46 over bottom surface 61 of composite wood base 12 (as shown in FIGS. 6C, 7C, and 8D). Turning to FIG. 5, the process described herein can also be utilized in connection with a composite wood base 12 in which side edge 62 has a straight/flat/fluted profile (FIG. 5 is oriented from an upstream to downstream perspective with the first nip rollers 52 being absent to better illustrate the circumference of side portions 74 of top roller 73 whereas the other perspective views are oriented from a downstream to upstream perspective).

In addition, in embodiments where the side edge 62 of composite wood base 12 defines a grooved surface 64, one or more side rollers 56 can also include a portion 59 (which may be in addition to portion 57 or, as illustrated, separate from and exclusive of portion 57) which has an increased circumference when compared to the main body portion 58 of side roller that is configured to apply surface material 46 into such groove (as shown in FIG. 8C). In this manner, the entirety of the board can be wrapped with surface material 46.

Referring again to FIG. 4A, film application section 50 includes third nip rollers 82 from which additional pressure is applied to surface material 46 to better adhere surface material 46 to the top surface 60 and/or bottom surface 61 of composite wood base 12. Third nip rollers 82 are positioned such that they can be adjacent to top surface 60 and bottom surface 61 of composite wood base 12. The application of surface layer 46 onto composite wood base 12 results in composite wood product 10.

Once a surface layer 46 has been formed on the composite wood base 12, the surface layer 46 and/or the composite wood base 12 can be fed through third heater section 90 and then heated embossing nip 92 to form a desired surface design in the composite wood product 10. For instance, in certain embodiments, the surface design can simulate wood grain. However, other patterns can also be utilized if desired. The embossing nip 92 can assist in applying the surface material 16 to the wood base 12. It has been determined that heating the composite wood base 12 provides embossing depth improvement while drawing the thermoplastic material (which appears to have an affinity for the metal surface of an embossing roller) towards the surface which beneficially helps to seal the composite wood base 12. The embossing nip 92 can emboss one or more of the top, bottom, or side surfaces of the composite wood product 10.

Once the composite wood product 10 has been formed, it can be cut to a desired and predetermined length by a conventional cutter 84 and packaged for shipment. Importantly, the present disclosure contemplates utilization of sensors at the beginning of the process (in which wood base 12 can be stacked prior to being fed onto conveyor) wherein the sensors register the leading edge and trailing edge of each wood base with subsequent boards being fed from the stack onto the conveyor and abutted with the board that was fed previously, each subsequent board leading edge and trailing edge also being registered. In this manner, the surface layer 46 can be applied continuously and the cutter 84 can cut the boards at the exact location of abutment, thereby allowing wood bases 12 of different lengths to be utilized simultaneously in the process of the present disclosure. Any conventional sensors as would be known in the art can be utilized, including photo eyes or the like.

Again, it should be understood that variations can be made in the above-described process that are within the scope and spirit of the present disclosure. It will be appreciated that the inventive method described herein allows for the formation of composite wood products having properties which greatly resemble the properties of natural wood while having much fewer additives than conventional products.

The present disclosure can be better understood with reference to the following examples.

### EXAMPLES

### Example 1

Base:

48% wood

1% pigment

0.5% UV stabilizer

2% magnesium stearate

48% polypropylene

Surface Layer:

30% calcium carbonate

3% UV stabilizer

10% pigment

56% polypropylene

### Example 2

Base:

58% Wood

38% Polyethylene

0.5%-1% UV Stabilizer

2% Magnesium Stearate

1% pigment

Surface Layer:

56% Polyethylene

30% Calcium Carbonate

10% Pigment

3% UV Stabilizer

### Example 3

Base:

85% PVC

15% Organic blend

UV Stabilizer

Titanium Dioxide

Talc

Surface Layer:

75% PVC

15% Proprietary organic blend

UV Stabilizer

TiO2 (Titanium Dioxide)

10% Pigment

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed is:

1. A method for making a composite wood product comprising:
extruding a mass comprising fiber material and thermoplastic resin to form a composite wood base;
heating the composite wood base;
laminating a sheet of surface material onto the composite wood base with a film application device to form a composite wood product, the film application device capable of wrapping a single sheet of the surface material onto the top, bottom, and side surfaces of the composite wood base.

2. The method of claim 1, further comprising embossing at least a portion of the composite wood product.

3. The method of claim 2, wherein the composite wood product is heated prior to embossing.

4. The method of claim 1, wherein the composite wood product is heated during embossing.

5. The method of claim 1, wherein the thermoplastic resin comprises polyvinyl chloride.

6. The method of claim 1, wherein the fiber material comprises wood fiber.

7. The method of claim 1, wherein the surface material comprises polyvinyl chloride.

8. The method of claim 7, wherein the surface material further comprises a filler material, the filler material comprising carbonate, talc, silica, or combinations thereof.

9. The method of claim 1, wherein the mass further comprises at least one lubricant and at least one blowing agent.

10. The method of claim 1, wherein heating the composite wood base comprises passing the composite wood base through at least two heating chambers having different temperatures therein.

11. The method of claim 1, wherein the film application device comprises:
at least one roller capable of applying the sheet of the surface material onto the top surface of the composite wood base and fold the sheet over the side surfaces of the composite wood base; and
at least two rollers capable of applying the sheet of the surface material onto the side surfaces of the composite wood base and fold the sheet over the bottom surface of the composite wood base.

12. The method of claim 11, wherein the film application device further comprises at least one heater that is configured to heat the sheet of surface material, the composite wood base, or combinations thereof.

13. The method of claim 11, wherein the film application device further comprises at least one roller capable of applying the sheet of the surface material onto the bottom surface of the composite wood base.

14. A method for making a composite wood product comprising:
extruding a mass comprising fiber material and thermoplastic resin to form a composite wood base;
heating the composite wood base;
laminating a sheet of surface material onto the composite wood base with a film application device to form a composite wood product, the film application device comprising at least one roller capable of applying the sheet of the surface material onto the top surface of the composite wood base and fold the sheet over the side surfaces and the composite wood base and at least two rollers capable of applying the sheet of the surface material onto the side surfaces of the composite wood base and fold the sheet over the bottom surface of the composite wood base.

15. The method of claim 14, further comprising embossing at least a portion of the composite wood product.

16. The method of claim 15, wherein the composite wood product is heated prior to embossing.

17. The method of claim 14, wherein the composite wood product is heated during embossing.

18. The method of claim 14, wherein the thermoplastic resin comprises polyvinyl chloride.

19. The method of claim 14, wherein the fiber material comprises wood fiber.

20. The method of claim 14, wherein the surface material comprises polyvinyl chloride.
